(19) United States
(12) Patent Application Publication
(10) Pub. No.: US 2008/0310494 A1
(43) Pub. Date: Dec. 18, 2008

(54) Leakage Scheme for Receiver

(75) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,630

(22) PCT Filed: Dec. 14, 2006
(86) PCT No.: PCT/IB06/54839

§ 371 Date: Jun. 16, 2008

(30) Foreign Application Priority Data
Dec. 20, 2005 (EP) 05301091.4

(51) Int. Cl. H04L 27/01; H04L 27/06

(52) U.S. Cl. 375/232; 375/316; 375/341

(57) ABSTRACT

A receiver for processing a transmission signal distorted by a transmission channel is described. The receiver has an adaptive signal processor (101) for processing the transmission signal based on at least one processing parameter for generating a processed signal, and a difference detector (13) for detecting a difference between the processed signal and an expected signal, and a setting unit (14) for adapting the at least one processing parameter towards a new parameter value in dependence on the difference. The setting unit has a leakage unit (141) arranged for setting a leakage target value for the at least one processing parameter, the leakage target value being different from zero, and further adapting the at least one processing parameter based on a leakage component in a direction towards the leakage target value.

### FIELD OF THE INVENTION

The invention relates to a receiver for processing a transmission signal, the transmission signal being distorted by a transmission channel, the receiver comprising an input for receiving the transmission signal, adaptive signal processing means for processing the transmission signal based on at least one processing parameter for generating a processed signal, difference detection means for detecting a difference between the processed signal and an expected signal, and setting means for adapting the at least one processing parameter towards a new parameter value in dependence on the difference.

The invention further relates to a method of processing a transmission signal, the transmission signal being distorted by a transmission channel, the method comprising receiving the transmission signal, processing the transmission signal based on at least one processing parameter for generating a processed signal, detecting a difference between the processed signal and an expected signal, and adapting the at least one processing parameter towards a new parameter value in dependence on the difference.

In particular the invention relates to the field of adaptive control, and leakage of parameters therein. Adaptive control is widely used in modern digital circuits. In particular, in digital transmission systems, adaptive equalization provides a very effective means to increase the system robustness with respect to the changing environment conditions. Optical disc systems (CD, DVD, BD, etc.) form a class of such systems. Here, the adaptive equalization is applied to increase the system robustness with respect to the disc tilt, defocus and other disturbances. In addition to the adaptive equalization, adaptive channel estimation is often used in the systems employing the Partial Response Maximum Likelihood (PRML) bit detection.

### BACKGROUND OF THE INVENTION

A device and method for receiving signals from a transmission channel are known from the document “Signal processing for 35 GB on single-layer Blue-ray Disc, by A. Padiy et al, in the journal PROCEEDINGS-SPIE THE INTERNATIONAL SOCIETY FOR OPTICAL ENGINEERING, 2004, Vol. 5380, pages 56-70, published by the International Society for Optical Engineering, USA, ISSN 0277-786β” (called doc1). Doc1 discusses technical progress in increasing the recording density of optical storage systems by means of improved read-channel signal processing and write-channel optimization. The recording density increase is realized by employing PRML (Viterbi) bit detection in combination with improved timing recovery and adaptive equalization algorithms for the signals retrieved from the transmission channel constituted by the record carrier at the considered range of storage densities.

However, the above systems for receiving signals and adaptively processing the transmission signals may be inaccurate and may lack stability and robustness in adverse conditions of the transmission channel.

### SUMMARY OF THE INVENTION

Therefore it is an object of the invention to provide a device and method for processing a transmission signal.

According to a first aspect of the invention the object is achieved with a receiver as described in the opening paragraph, wherein the setting means comprise leakage means arranged for setting a leakage target value for the at least one processing parameter, the leakage target value being different from zero, and further adapting the at least one processing parameter based on a leakage component in a direction towards the leakage target value.

According to a second aspect of the invention the object is achieved with a method as described in the opening paragraph, which method comprises setting a leakage target value for the at least one processing parameter, the leakage target value being different from zero, and further adapting the at least one processing parameter based on a leakage component in a direction towards the leakage target value.

The effect of the measures is that the adaptation of the processing parameter is based on a suitable adaptation system based on differences with an expected signal, and in addition a leakage component is applied. Leakage is a way of adjusting the value of a parameter, traditionally in analog circuit reducing the value of the parameter by leaking away a leakage component to ground level. However, contrary to known leakage schemes which inherently leak the value of a parameter to zero, the novel leakage system leaks to an arbitrary leakage target value. This advantageously results in a robust and stable processing system that has an inherent tendency to converge towards the setting as arbitrarily selected by the leakage target value.

The invention is also based on the recognition that adaptive circuits may be slow or cause problems due to their instability in adverse conditions. Slow convergence may occur if much disturbance is present. Instability in the adapting process might occur if various phenomena interact with the transmission signal. In the known prior art systems leakage is a simple yet very effective means to improve the stability of the adaptive systems.

For example, in case of the adaptive equalizer driven by the Least Mean Square (LMS) algorithm, leakage is being widely used to stabilize the adaptation of the filter coefficients. In such systems, the LMS-based adaptation of the filter coefficients (taps) f^{p} is based on the formula

f_{new}^{p}=f_{old}^{p}+β·Δ^{p}

The adaptation is supplemented by the tap leakage

f_{new+leakage}^{p}=(1−α)·f_{new}^{p}

with some small positive α<1. As a result, the filter coefficient become uniquely defined even in the case when the LMS update term Δ^{p} is absent at certain frequencies (this is the case in the optical disc systems like CD, DVD and BD for the frequencies above the cut-off frequency of the optical channel), and therefore stability of the LMS-based adaptation circuit is achieved. Leakage has deep historical roots originating in the analog circuits, and inherently has the meaning of decreasing a value of a parameter towards zero by small amounts, called now “leakage towards zero”, since the taps f^{p} are driven towards zero by the supplementing update step. However, in many practical cases the stability problems are difficult to solve by such a simple technique.

U.S. Pat. No. 4,575,857 provides an example of a more complex leakage scheme. An automatic equalizer comprises a waveform equalizer having a transversal filter connected to receive an input signal having a linear distortion, and having controllable tap gains; and a tap gain correcting means for successively correcting the tap gains of the transversal filter to take from the transversal filter an output signal from which the linear distortion is removed. In order to maintain good convergence of tap gain correction control and prevent the excessive increase of the residual distortion, the tap gain correcting means is arranged to add a small leak to the correction control of tap gains. In the system the leak of the tap gain parameters is towards zero, e.g. as mentioned in col.3, lines 38-40. In addition in col.4 lines 30-38, a decision to leak, or the magnitude of the leak, is based on the sum of absolute values of the differences between the tap gains and their predetermined values to be set when the input signal contains no distortion. Hence a strong leak to zero is applied when said sum is large (i.e. when much disturbance is present), whereas a small leak, or no leak, is applied when said sum is small.

Currently, the inventors have provided a more effective, different leakage system. The inventors have seen that the system of leakage towards zero can be modified to a novel concept of leaking towards a target value. Basically the leakage towards target values of processing parameters results in an inherently stable system having a selected response, while still allowing adapting the processing to deviations in the transmission channel. It is noted that the current invention may be combined with a system to decide to leak or not to leak in dependence of a difference between actual values and target values, e.g. as discussed above referring to U.S. Pat. No. 4,575,857.

In an embodiment the receiver comprises detection means for detecting a property of the transmission channel, and the leakage means are arranged for setting the leakage target value for the at least one processing parameter in dependence of the property. This has the advantage that the target value is adjusted in dependence of the detected property of the transmission channel. It is noted that detecting the property may be performed in any suitable way, e.g. by physical measurements, by analyzing the transmission signal, or by retrieving system information from the transmission system. Note that in a particular case the transmission channel is an optical storage system and the property is tilt representing a tilt angle between an optical axis of an optical head and a perpendicular of a data layer on a record carrier. The tilt may be detected by a separate tilt detection system, and the detected radial or tangential tilt is advantageously used to calculate and set the leakage target values.

In an embodiment of the receiver the adaptive signal processing means comprises different control loops, and the leakage means arranged for setting the leakage target value for the at least one processing parameter for at least one of the loops for reducing interaction between the different control loops. This has the advantage that the different loops converge more quickly, because the stability is less affected by other loops. In a particular case one of the loops comprises an equalization means having a number of tap parameters controlling respective taps of a digital impulse response filter and said further adapting being towards symmetric tap parameters. The symmetric tap parameters have the advantage that a target value for such tap parameters can still be adapted, taking into account the symmetry requirement.

Further preferred embodiments of the device and method according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a receiver having adaptive signal processing,

FIG. 2 shows an adaptive equalizer,

FIG. 3 shows a scanning device with tilt detection,

FIG. 4 shows a signal processing unit having different adaptive control loops, and

FIG. 5 shows a process of adaptive signal processing of a transmission signal.

In the Figures, elements which correspond to elements already described may have the same reference numerals.

### DESCRIPTION OF THE PREFERRED EMBODIMENTS

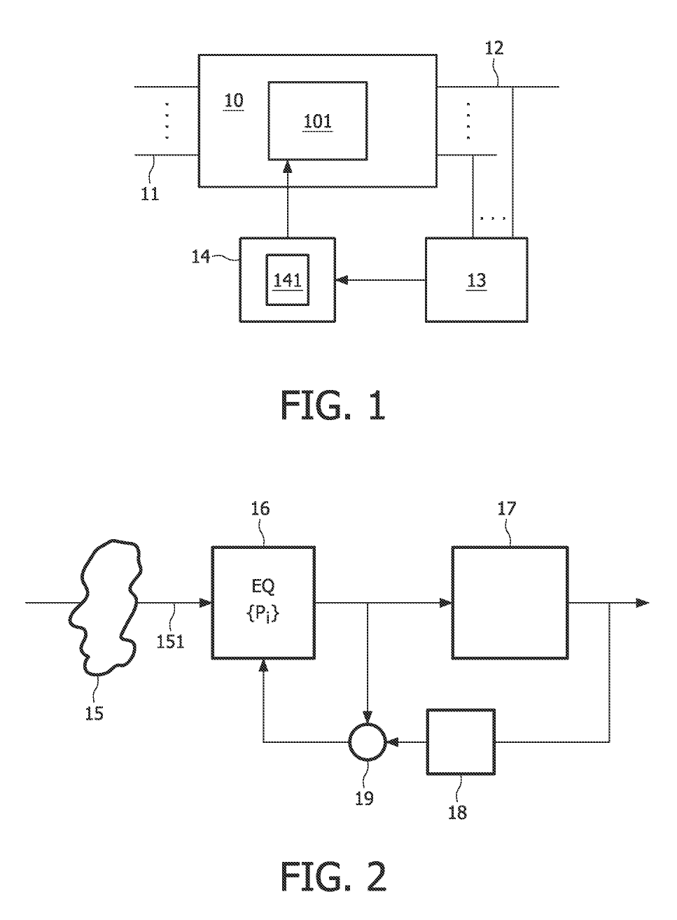

FIG. 1 shows a receiver having adaptive signal processing. The FIG. schematically shows a receiver 10 having one or more inputs 11 and one or more outputs 12. The receiver is provided with a processing unit 101, e.g. a signal equalizer, for processing signals from the input based on processing parameters, e.g. filter parameters. The processed signals may be coupled to the output 12, or may be further processed or analyzed in the receiver, e.g. for displaying video on a display (not shown). The receiver has a detection unit 13 that detects a difference of the processed signal and an expected signal, e.g. an expected frequency spectrum is compared to a spectrum of the processed, received signals. The output signals 12 may be used directly or indirectly for the comparison as discussed below in detail. The receiver has a setting unit 14 for determining values of the processing parameters in the processing unit 101, i.e. adapting the processing parameters based on detected differences, e.g. using the well-known Least Mean Square (LMS) algorithm. The setting unit 14 is provided with a leakage unit 141 for additionally adjusting the processing parameters in the processing unit 101 based on a leakage scheme as follows. First a leakage target value is determined for the respective processing parameter, which leakage target value is different from zero. Subsequently the processing parameter is further adapted based on a leakage component in a direction towards the leakage target value. For example the leakage target value is a predetermined value based on the known properties of the transmission channel via which the input signal is received.

In general the receiver receives and adaptively processes a transmission signal, which transmission signal has been distorted by a transmission channel. The receiver has an input for receiving the transmission signal, and has an adaptive system for adaptively processing the transmission signal based on one or more processing parameters for generating a processed signal. A detector detects differences between the processed signal and an expected signal, and an adapter adapts the processing parameters towards new parameter values in dependence on the difference. The adapting includes setting leakage target values for the processing parameters, the leakage targets value being different from zero, and adapting the processing parameters based on leakage components in a direction towards the leakage target values. The adaptive system A may be an equalizer, channel response estimation unit, gain control circuit, etc, characterized by a set op operating parameters {P_{i(A)}} which are adaptive.

The adapting of the operating parameters may be affected by various influences leading to stability problems or slow conversion. A stable solution may be known as a system B, having essentially the same function as the adaptive system A based on the parameters {P_{i(A)}}, but having specific values of the parameters {P_{i(B)}}. The solution of the stability is achieved by leaking the parameter values of unit A towards the leakage target values {P_{i(B)}}, for example according to the formula:

\tilde{P}_{i(A)}=P_{i(A)}−αᵢ(P_{i(A)}−P_{i(B)})

The value of the factor α may be adjusted to the amount of leakage that is required.

It is to be noted, that for circumventing the restrictions of the classical leakage scheme with leakage towards zero, a concept of leakage towards an arbitrary target is used. We define leakage towards an arbitrary target f_{target}^{p} as

f_{new+leakage}^{p}=f_{new}^{p}−α·Lₚ(f_{new}^{p}−f_{target}^{p}),

where the leakage target f_{target}^{p} is application-specific, and can be either pre-defined or variable depending on the state of the system, and Lₚ is an odd function. In mathematics, even functions and odd functions are functions which satisfy particular symmetry relations, with respect to taking additive inverses. A function is odd if f(−x)=−f(x). Particular choices of Lₚ could be Lₚ(x)=x, Lₚ(x)=x²ⁿ⁺¹ for some integer n. One can also define Lₚ to be zero in a certain range of its input arguments (normally around zero), and take non-zero values otherwise (normally for large values of the argument). By doing so, the leakage “strength” can be made variable.

FIG. 2 shows an adaptive equalizer. An input signal 151 is transmitted via a transmission channel 15, and may be denoted as Rₖ, an input signal corresponding to an original symbol sequence aₖ. The input signal is processed in an adaptive equalizer 16 based on parameters {Pᵢ} for producing a processed signal ãₖ, which is analyzed in a detector 17 according to a desired channel response g to which the detector is tuned. Response unit 18 generates an expected signal, which is compared in difference unit 19 with the processed signal. The resulting differences are used for adapting the parameters {Pᵢ}. The detector produces a signal âₖ being the detected estimates of the channel symbols. The transmission channel has the response h=hₙₒₘ+h_{dist}, i.e. a nominal component and a component due to distortions. The equalizer has two tasks, i.e. transforming hₙₒₘ to g (in so called static mode) based on {Pᵢ₋ₙₒₘ} and compensate for h_{dist} such that the channel response at the equalizer output remains close to g even in the presence of channel distortions (“dynamin mode”). In addition a leakage is used to further adapt the filter parameters {Pᵢ} of the equalizer. The leakage is towards a leakage target value different from zero, in particular by leaking parameters {Pᵢ} towards the static values {Pᵢ₋ₙₒₘ}.

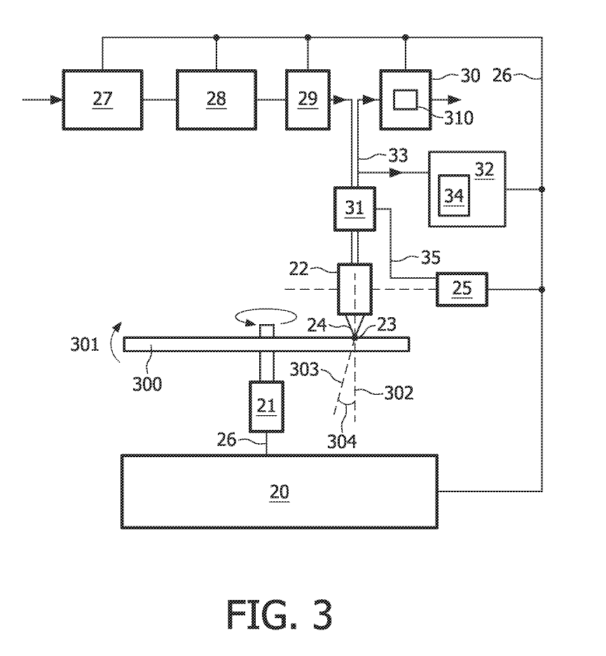

FIG. 3 shows a scanning device with tilt detection. The device is provided with scanning means for scanning a track on a record carrier 300 which means include a drive unit 21 for rotating the record carrier 300, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25.

In optical drives, the read-out performance is often degraded by tilt. Tilt is the angle between an optical axis of the optical head and a perpendicular of the data layer of the record carrier. Two types of tilt exist, called tangential tilt and radial tilt. With tangential tilt the spot is tilted in the track direction, which distorts the optical channel and causes severe inter-symbol interferences (ISI). With radial tilt the spot is tilted towards the neighbouring tracks, in which the neighbouring track data enter the target track read-out in the form of inter-track interference (ITI) or cross talk (XT). A tilt estimator may be included with which the tilt can be corrected in either a mechanical or signal processing way. The detected tilt may be used to adjust the leakage target values for adjusting the signal processing parameters according to the expected channel distortions resulting from the detected tilt.

The record carrier 300 may exhibit a tilt as schematically indicated by arrow 301. For example the tilt may result from a non-flat surface, a non perfect mechanical support, or scanning system offset, etc. A tilt angle 304 is defined at the position of the scanning spot 23, as the angle between an optical axis 302 of the head 22 and a perpendicular 303 of data layer of the record carrier. Note that in practice the tilt angle is about 1 degree or less, and the Figure is not drawn to scale.

The head, or the record carrier support system, may further include tilt actuators for adapting a tilt angle between a perpendicular to the data layer and an optical axis of the optical system of the head. The tilt actuators may be controlled based on the tilt signal generated as discussed below.

For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The main scanning signal 33 is processed by read processing unit 30 of a usual type including a demodulator, deformatter and output unit to retrieve the information. The control unit 20 comprises control circuitry, for example a microprocessor, a program memory and control gates. The control unit 20 may also be implemented as a state machine in logic circuits.

The device may be provided with recording means for recording information on a record carrier of a writable or re-writable type. The recording means comprise an input unit 27, a formatter 28 and a laser unit 29 and cooperate with the head 22 and front-end unit 31 for generating a write beam of radiation. The formatter 28 is for adding control data and formatting and encoding the data according to the recording format, e.g. by adding error correction codes (ECC), synchronizing patterns, interleaving and channel coding. The formatted units comprise address information and are written to corresponding addressable locations on the record carrier under the control of control unit 20. The formatted data from the output of the formatter 28 is passed to the laser unit 29 which controls the laser power for writing the marks in a selected layer.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1 (PHN16452), and for video in the MPEG2 standard. The input unit 27 processes the audio and/or video to units of information, which are passed to the formatter 28. The read processing unit 30 may comprise suitable audio and/or video decoding units.

The device has a tilt detection unit 32 for detecting a tilt and, in dependence thereon, generating a tilt signal based on a diagonal push-pull signal. The tilt signal may be coupled to the servo unit 25, providing a tilt error signal for adjusting the tilt servo. Alternatively, or additionally, the tilt signal may be used elsewhere, e.g. to adjust a recording process or to adapt the processing of the read signal in read unit 30, e.g. by compensating an amount of inter track cross-talk which is related to the amount of tilt represented by the tilt signal. The tilt signal may, for example, be determined as discussed in detail in WO 2004/105028. The tilt detection unit 32 may also be implemented as a software function in the control unit 20, using the front end unit 31, and the read circuitry in read unit 30, for providing selected sub-detector signals for generating the diagonal push-pull signal.

It is noted that the read unit 30 may comprise a PRML bit detector 310, as discussed below in detail.

In optical storage systems, an adaptive equalizer is often used to shape the channel response according to the requirements of the bit detection circuit, and to combat the channel distortions due to disc tilt, defocus, etc. As shown in FIG. 3 the read unit 30 may constitute an adaptive processing unit, which may include an adaptive equalizer. The taps of the adaptive equalizer are automatically adjusted in such a way that the equalizer compensates for tilt, defocus, etc. in order to make sure that the overall channel response after the equalization is largely free from the above distortions. Adaptation is normally performed by means of the Least Mean Squares (LMS) algorithm, see doc1 for examples. Both input waveform sample and the corresponding data bits are used in the adaptation algorithm.

In a first embodiment, because the exact data bits are normally unknown, the bit decisions produced by the bit-detector in read unit 30 are used instead. Without the leakage scheme the LMS adaptation loop may experience stability problems when the quality of the bit decisions is low. Such a situation occurs when local defects are present on the media or when the media quality is bad, and also during the drive start-up when the timing recovery and the DC compensation loops are not fully in lock yet causing bit detection problems. Under these circumstances, the LMS adaptation loop may diverge causing the whole receiver to fail.

Leakage towards a non-zero target provides a solution to this problem. As was already mentioned, the tasks of the adaptive equalizer can be split in 2 groups: first, the nominal channel response is shaped, and, second, the channel distortions are compensated for. Since the channel distortions are normally relatively small, the equalizer taps can be represented as

f^{p}=fₙₒₘ^{p}+f_{dist}^{p},

where fₙₒₘ^{p} is the large nominal component to which the taps converge under nominal read-out conditions without channel distortions, and f_{dist}^{p} denotes the relatively small correction to the tap values required for tackling the channel distortions. Normally, fₙₒₘ^{p} is known a-priori because the nominal transmission channel is well defined. Leakage towards f_{target}^{p}=fₙₒₘ^{p} provides very effective means for ensuring the adaptation stability: the tap values f^{p} will not be allowed to diverge if we chose the function Lₚ such that leakage is small when f^{p} deviates little from fₙₒₘ^{p}, but becomes large otherwise. Effectiveness of this scheme has been already shown experimentally. Note that the proposed scheme is not LMS-specific. It can be combined with other types of the tap adaptation algorithm as well.

In a second embodiment a leakage target value is determined for improving both the robustness and the convergences speed of the adaptive equalization schemes. In the first embodiment the pre-defined leakage target f_{target}^{p} was chosen. In general, however, the leakage target can be made adaptive. Let us consider the case when a fast dynamically updated estimate of the tangential tilt is available in the optical disc system, e.g. as discussed above with reference to FIG. 3. For example tangential tilt may be detected as described in WO 2004/105026. The estimated tilt values are used for adjusting the tap values of the equalizer based on a predetermined relation between tilt and the required target values. The scanning device as shown in FIG. 3 may include a lookup table 34, e.g. as part of the tilt detection unit 32, that contains sets of leakage target values as a function of tilt.

In the absence of other disturbances, the equalizer taps f^{p} can be defined in a feed-forward manner as a function of the tangential tilt, since the tangential tilt causes a well-defined controllable distortion to the transmission channel, which can be characterized in advance. In this case, the equalizer taps can be represented as

f^{p}=fₙₒₘ^{p}+fₜᵢₗₜ^{p},

where fₙₒₘ^{p} is the large nominal component to which the taps converge under nominal read-out conditions without channel distortions, and fₜᵢₗₜ^{p} denotes the tilt-dependent correction to the tap values required for tackling the tangential tilt. In the case when other disturbances are also present, the equalizer taps can be represented as

f^{p}=fₙₒₘ^{p}+fₜᵢₗₜ^{p}+f_{dist}^{p},

where f_{dist}^{p} denotes the correction to the tap values required for tackling all the other disturbances except for the tangential tilt. In both cases, the tilt-dependent component fₜᵢₗₜ^{p} can be computed based on the available estimate of the tangential tilt. By introducing in the LMS adaptation algorithm a leakage towards f_{target}^{p}=fₙₒₘ^{p}+fₜᵢₗₜ^{p}, not only the LMS robustness can be improved as in the first embodiment, but also the LMS adaptation speed with respect to the changes in the tangential tilt. The leakage scheme therefore can be used to combine the two different adaptation mechanisms: the tilt-specific one and the LMS-based one.

The same approach can be used when other known disturbances are present in the system, for example defocus, radial tilt, etc. In this case, the equalizer taps can be represented as

f^{p}=fₙₒₘ^{p}+f_{known}^{p}+f_{dist}^{p},

where f_{known}^{p} denotes the correction to the tap values required for tackling all the known disturbances, and f_{dist}^{p} denotes the correction to the tap values required for tackling all the other disturbances except for the known ones.

In a third embodiment the robustness and convergence speed of the reference level update scheme for a PRML bit detector, e.g. PRML bit detector 310 as shown in FIG. 3, is improved. PRML (Viterbi) bit detection is widely used in the modern digital transmission systems, in particular in DVD and BD optical disc storage systems. A channel estimation circuit is needed for facilitating the PRML detection. We refer to doc1, in particular Chapter 2 thereof, for an example of such a channel estimation circuit. The channel estimation is performed based on the waveform samples and on the corresponding data bits. Similarly to the adaptive equalizer case, exact data bits are not readily available in the receiver and, therefore, bit decisions produces by the bit detector are normally used instead. This leads to instability of the channel estimation process in the case when the bit decisions are of poor quality (during the receiver start-up, for example, or when the optical head passes a media defect). If the channel estimation circuit starts producing “wrong” input for the PRML bit detector, the quality of bit decisions drops further down, and the channel estimation circuit becomes even worse leading to the breakdown of the whole receiver.

Leakage to the non-zero target can provide a solution for this problem as well. Similarly to the first and second embodiments, leakage to the known channel state can be applied. The reference levels can be pre-computed as a function of the known channel disturbances, and leakage towards this known state will lead to better robustness and to better adaptation speed.

In a particular embodiment of the reference level update for the PRML bit detection the adaptive levels may be set corresponding to a combination of a fixed linear channel response and an adaptive estimate of the signal asymmetry. The signal asymmetry in an optical recording transmission channel is a systematic imperfection which may be caused by the writing process or the manufacturing of the record carrier. The document “Modeling and Compensation of Asymmetry in Optical Recording” by H. Pozidis et al, in IEEE Transactions in Communications, Vol. 50, No. 12, December 2002, describes detecting such asymmetry. According to the current leakage scheme leakage target values are determined for the processing parameters, i.e. the adaptive reference levels, in the PRML bit detection.

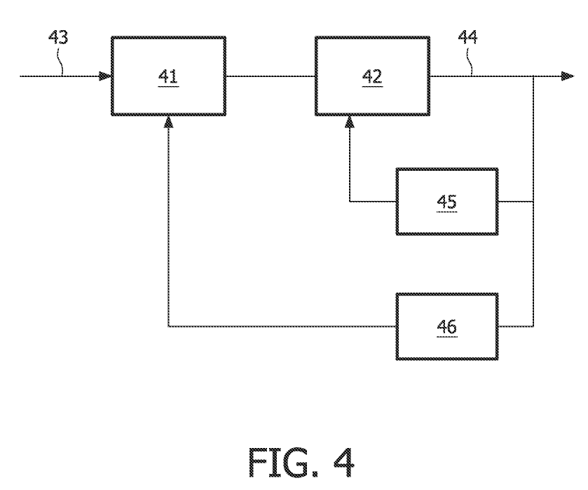

FIG. 4 shows a signal processing unit having different adaptive control loops. An input signal 43 is received and processed in a first adaptive processing unit 41. An intermediate processed output signal is further processed in a second adaptive processing unit 42 for producing the processed output signal 44, which is analyzed in a first setting unit 45 for adapting the parameters in second adaptive processing unit 42, and also in a second setting unit 46 for adapting the parameters in first adaptive processing unit 41. In the fourth embodiment the interaction between the different control loops is decreased by applying leakage towards a non-zero target for at least one of the control loops. For example the first adaptive processing unit 41 may be an automatic gain control circuit (AGC1), having a nominal gain G. The second adaptive processing unit 42 may also have a gain that is affected by the setting of the respective second processing parameters. As both loops affect the gain, the system has instability, e.g. the first gain may increase beyond a safe operating range while the second gain decreases. Advantageously the first gain may be leaked towards the nominal value of one. For example the first loop, constituted by the first adaptive processing unit 41 and second setting unit 46 may respond quickly to gain variations in the transmission channel, but also be leaked towards the nominal gain G. The second loop is constituted by the second adaptive processing unit 42 and first setting unit 45, and may respond more slowly, but more accurately to slower variations of the transmission channel.

A further example of different control loops is asynchronous adaptive equalization, where interaction between the equalizer adaptation loop and the timing recovery loop (e.g. Phase Locked Loop, PLL) poses a serious problem. An example of asynchronous adaptive equalization is discussed in doc1 with reference to FIG. 2 thereof.

The leakage towards a non-zero target is used to suppress the unwanted interaction between timing and equalization. For example, leakage of the taps of the adaptive equalizer either towards a certain pre-defined taps setting or towards a symmetric setting can be used. A further example of different loops and interaction is a system having a gain control loop and the adaptive equalizer loop. The overall system can be stabilized by leaking either the gain parameter or the equalizer taps towards a certain well-defined leakage target value. Note that the leakage target value(s) may possibly depend on the system state, which can be detected from system parameters or from an operational mode of the system.

In a fifth embodiment both the robustness and the convergences speed of the cross-talk cancellation schemes are improved. Crosstalk may occur due to radial tilt as discussed above. Cross-talk cancellation schemes are used for suppressing the inter-track cross-talk in the optical disc systems, and may use auxiliary signals generated in different channels, for example auxiliary readout signals from satellite spots in a 3-spot optical detection system, as discussed with reference to FIG. 8 in doc1.

Adaptive equalization is applied to the auxiliary readout signals before they are subtracted from the main channel signal. LMS-based algorithms are normally used for adapting the equalizers. In order to increase the system robustness and increase the convergence speed, leakage techniques similar to the ones described in the first and second embodiments can be applied. By the adapting and leakage of the auxiliary signals the receiver is arranged for combining the processed signal and a further transmission signal. The leakage unit is arranged for setting the leakage target value for the respective processing parameter in dependence of an interaction of the at least one of the transmission signals and the further transmission signal. The interaction may for example be radial tilt, defocus and spherical aberration, which are the main sources of the channel distortions. In case when a run-time estimate of these parameters (or some of them) is available, leakage of the adaptive equalizer taps towards the pre-computed sets of tap coefficients can be performed.

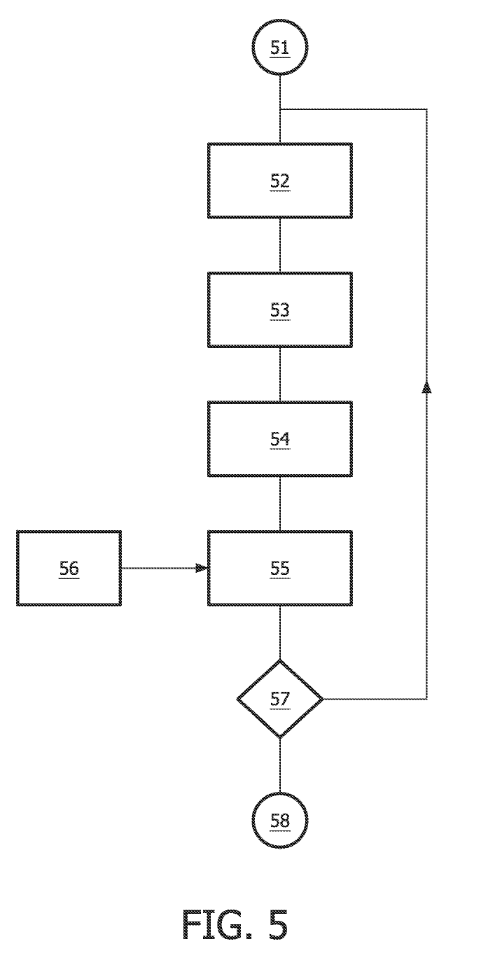

FIG. 5 shows a process of adaptive signal processing of a transmission signal. The transmission signal is distorted by a transmission channel. After the receiving system has been activated at node START 51, the process starts at node RECEIVE 52 by receiving the transmission signal. Next, at node PROCESS 53, the transmission signal is processed based on one or more processing parameters for generating a processed signal. The process continues at node DETECT DIFFERENCE 54, which detects a difference between the processed signal and an expected signal. The expected signal may be a predetermined signal, e.g. a signal parameter regarding amplitude or frequency components in the signal, or it may be a generated signal based on a signal detection step further on in the signal processing. In next step ADAPT PARAMETER 55, the processing parameters are adapted towards new parameter values in dependence on the difference. In parallel, at node SET LEAKAGE TARGET 56, leakage target values for the processing parameters are set, which leakage target values are different from zero. The leakage target values are based on predetermined, or measured, properties of the transmission channel as discussed above. The process step ADAPT PARAMETER 55 further includes adapting the processing parameters based on a leakage component in a direction towards the leakage target value. At node CONTINUE 57 it is detected if further signals need to be processed, starting again at node RECEIVE 52, or terminating the process at node STOP 58.

Although the invention has been mainly explained by embodiments using optical discs as transmission channel, the invention is also suitable for other transmission channels having varying distortions, such as wireless networks.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Receiver for processing a transmission signal, the transmission signal being distorted by a transmission channel, the receiver comprising
an input (11) for receiving the transmission signal,
adaptive signal processing means (101) for processing the transmission signal based on at least one processing parameter for generating a processed signal,
difference detection means (13) for detecting a difference between the processed signal and an expected signal, and
setting means (14) for adapting the at least one processing parameter towards a new parameter value in dependence on the difference, the setting means comprising leakage means (141) arranged for
setting a leakage target value for the at least one processing parameter, the leakage target value being different from zero, and
further adapting the at least one processing parameter based on a leakage component in a direction towards the leakage target value.

2. Receiver as claimed in claim 1, wherein the receiver comprises detection means (32) for detecting a property of the transmission channel, and the leakage means (141) are arranged for setting the leakage target value for the at least one processing parameter in dependence of the property, in a particular case the transmission channel being an optical storage system and the property being tilt representing a tilt angle between an optical axis (302) of an optical head (22) and a perpendicular (303) of a data layer on a record carrier (300).

3. Receiver as claimed in claim 1, wherein the leakage means (141) arranged for said adapting the at least one processing parameter f_{new+leakage}^{p} based on the formula
f_{new+leakage}^{p}=f_{new}^{p}−α·Lₚ(f_{new}^{p}−f_{target}^{p}),
where the new parameter value is indicated by f_{new}^{p}, the leakage target value is indicated by f_{target}^{p}, the α is a constant different from zero, and Lₚ is an odd function, in a particular case the odd function Lₚ being Lₚ(x)=x, or Lₚ(x)=x²ⁿ⁺¹ for n being an integer different from zero.

4. Receiver as claimed in claim 1, wherein the adaptive signal processing means (101) comprises an equalization means (16) having a number of filter parameters, in a particular case the filter parameters controlling respective taps of a digital impulse response filter.

5. Receiver as claimed in claim 4, wherein the equalizer means (16) has an equalizer response split into groups, and a nominal group being based on a nominal transmission channel and the leakage target value being based on a-priori knowledge of the nominal transmission channel, in a particular case the parameter f^{p} being based on the formula
f^{p}=fₙₒₘ^{p}+f_{dist}^{p}
where fₙₒₘ^{p} denotes the nominal component of the nominal transmission channel, and f_{dist}^{p} denotes a correction representing distortions of the transmission channel.

6. Receiver as claimed in claim 4, wherein the equalizer means (16) has an equalizer response split into at least two groups, and a nominal group being based on a nominal transmission channel and the leakage target value comprising a first leakage target being based on a-priori knowledge of the nominal transmission channel and a second leakage target being based on an expected deviation of the nominal transmission channel, in a particular case the parameter f^{p} being based on the formula
f^{p}=fₙₒₘ^{p}+fₑₓₚ^{p}+f_{dist}^{p},
where fₙₒₘ^{p} denotes the nominal component of the nominal transmission channel, and fₑₓₚ^{p} denotes the expected deviation such as a tilt-dependent correction fₜᵢₗₜ^{p} representing tilt of an optical readout system, and f_{dist}^{p} denotes a correction representing distortions of the transmission channel for other disturbances except the expected deviation.

7. Receiver as claimed in claim 6, wherein the leakage means (141) are arranged for detecting a characteristic of the transmission channel as the expected deviation of the nominal transmission channel, in a particular case the tilt-dependent correction fₜᵢₗₜ^{p} being based on a detected estimate of the tangential tilt.

8. Receiver as claimed in claim 1, wherein the adaptive signal processing means (101) comprises a bit detector means (310) having a number of channel parameters representing a channel state, in a particular case the channel parameters being reference levels in a partial response maximum likelihood detector.

9. Receiver as claimed in claim 1, wherein the adaptive signal processing means comprises different control loops (41,46;42,45), and the leakage means (141) are arranged for setting the leakage target value for the at least one processing parameter for at least one of the loops for reducing interaction between the different control loops.

10. Receiver as claimed in claim 1, wherein the adaptive signal processing means (101) comprises an equalization means having a number of tap parameters controlling respective taps of a digital impulse response filter and said further adapting the at least one processing parameter is based on a leakage component in a direction towards symmetric tap parameters.

11. Receiver as claimed in claim 1, wherein the input for receiving the transmission signal is arranged for receiving multiple transmission signals from related transmission channels, and
the adaptive signal processing means (101) is arranged for processing at least one of the transmission signals based on at least one processing parameter for generating the processed signal, and the receiver is arranged for combining the processed signal and a further transmission signal, and the leakage means (141) are arranged for
setting the leakage target value for the at least one processing parameter in dependence of an interaction of the at least one of the transmission signals and the further transmission signal.

12. Method of processing a transmission signal, the transmission signal being distorted by a transmission channel, the method comprising
receiving the transmission signal,
processing the transmission signal based on at least one processing parameter for generating a processed signal,
detecting a difference between the processed signal and an expected signal,
adapting the at least one processing parameter towards a new parameter value in dependence on the difference,
setting a leakage target value for the at least one processing parameter, the leakage target value being different from zero, and
further adapting the at least one processing parameter based on a leakage component in a direction towards the leakage target value.
